(19) United States
(12) Patent Application Publication
(10) Pub. No.: US 2006/0144866 A1
(43) Pub. Date: Jul. 6, 2006

(54) Gating system for flowable material and conveying apparatus including same

(75) Inventors: David Haitin, Ramat-Gan (IL); Reuven Serby, Tel-Aviv (IL)

Correspondence Address: Martin D Moynihan;Prtsi Inc, PO Box 16446, Arlington, VA, 22215, US

(73) Assignee: Serby-Tech Ltd., Tel-Aviv (IL)

(21) Appl. No.: 10/562,009

(22) PCT Filed: Jun. 24, 2004
(86) PCT No.: PCT/IL04/00563

§ 371 Date: Dec. 23, 2005

Related U.S. Application Data
(60) Provisional application No. 60/482,002, filed on Jun. 25, 2003.

(51) Int. Cl. G01F 11/14

(52) U.S. Cl. 222/243

(57) ABSTRACT

A gating system for controlling the flow of a flowable material through a passageway having an inlet and an outlet, the gating system includes: an inlet blade assembly between the passageway inlet and passageway outlet, the inlet blade assembly including an inlet blade and a drive for moving the inlet blade to open and closed positions with respect to the passageway; an outlet blade assembly between the inlet blade assembly and the passageway outlet, the outlet blade assembly including an outlet blade and a drive for moving the outlet blade to open and closed positions with respect to the passageway; and a control system that drives for moving the inlet blade to its closed position before moving the outlet blade to its closed position with respect to the passageway, and moves the outlet blade to its open position before moving the inlet blade to its open position.

### FIELD AND BACKGROUND OF THE INVENTION

The present invention relates to a gating system for controlling the flow of a flowable material. The invention is particularly useful in conveying apparatus for conveying a flowable material, such as grains, sand, plastic particles and powders, etc., from a large container, such as a silo or hopper, to another destination, such as a remotely-located storage container. The invention is therefore described below particularly with respect to such an application, but it will be appreciated it could also be used in many other applications.

At the present time, flowable material is commonly conveyed from one destination to another either by a mechanical conveyor, such as a rotary feeder, or by a pneumatic conveyer which conveys the material by pressurized air. Each has its advantages and disadvantages. For example, while mechanical feeders feed the material continuously, their feeding rate is very limited, and their contact with the flowable material, such as grains, can be damaging. The pneumatic conveying systems feed the material in batches and/or continuously, generally occupy a large space, and require costly installations and gating systems particularly because of the need for good sealing in order to avoid high losses in the pressurized air used for conveying the flowable materials.

### OBJECTS AND BRIEF SUMMARY OF THE PRESENT INVENTION

An object of the present invention is to provide a gating system having a number of advantages over those used today, which make such gating systems particularly useful in pneumatic apparatus for conveying flowable material. Another object of the invention is to provide an improved conveying apparatus including the novel gating system.

According to one aspect of the present invention, there is provided a gating system for controlling the flow of a flowable material through a passageway having an inlet and an outlet, the gating system comprising: an inlet blade assembly between the passageway inlet and passageway outlet, the inlet blade assembly including an inlet blade and a drive for moving the inlet blade to open and closed positions with respect to the passageway; an outlet blade assembly between the inlet blade assembly and the passageway outlet, the outlet blade assembly including an outlet blade and a drive for moving the outlet blade to open and closed positions with respect to the passageway; and a control system for controlling the drives for moving the inlet blade to its closed position before moving the outlet blade to its closed position with respect to the passageway, and for moving the outlet blade to its open position before moving the inlet blade to its open position with respect to the passageway.

As will be described more particularly below, the provision of two blade assemblies and there control as set forth above reduces the need for extremely reliable sealing in order to prevent undue loss of compressed air used in the pneumatic conveying operation.

According to further features in the preferred embodiments of the invention described below, the outlet blade assembly includes a seal cooperable with the outlet blade when in its closed position to seal the passageway and the inlet blade assembly therein. The seal may be an inflatable seal, in which case the control system would inflate the seal after the outlet blade has been moved to its closed position, and deflate the seal before the outlet blade is moved to its open position. This feature further reduces the possibility of losing compressed air during the operation of the gating system.

According to further features in the described preferred embodiments, the inlet blade assembly includes a pair of open frame members between which the inlet blade is movable to its open and closed positions. The open frame member of the inlet blade assembly facing the outlet blade assembly is interrupted to permit passage to the outlet blade assembly of flowable material located between the two frame members of the inlet blade assembly during the movement of the inlet blade to its closed position.

According to still further features in the described preferred embodiments, the outlet blade assembly also includes a pair of frame members between which the outlet blade is movable to its open and closed positions. The open frame member of the outlet blade assembly proximal to the passageway outlet carries, on its surface facing the other open frame member of the outlet blade assembly, a plurality of jet cleaning nozzles controlled by the control system for discharging cleaning jets towards the outlet blade to clean it during the opening and/or closing movements of the outlet blade.

According to still further features in one described embodiment, the outlet blade carries a plurality of jet cleaning nozzles controlled by the control system for cleaning the open frame members of the outlet blade assembly during the opening and/or closing movements of the outlet blade.

According to another aspect of the present invention, there is provided conveying apparatus including a gating system as set forth above; a container for containing a quantity of flowable material and for feeding same by gravity to the inlet of the passageway; a tank communicating with the outlet of the passageway; and a source of pressurized gas to pressurize the tank and to convey the flowable material therein to another destination; the control system also controlling the source of pressurized gas to pressurize the tank only when the outlet blade of the outlet blade assembly has been moved to its closed position.

According to a still further aspect of the present invention, there is provided a conveying system wherein the conveying apparatus comprises two gating systems, each underlying a part of the container, and two tanks, each underlying one of the gating systems and communicating with the source of pressurized gas; and wherein the control system controls the drives of the gating systems and the source of pressurized gas to alternatingly fill one tank with flowable material from the container via its gating system, while pressurizing the other tank to convey its contents to the another destination.

As will be described more particularly below, gating systems constructed in accordance with the foregoing features provide a number of important advantages which make them particularly useful for conveying flowable materials, such as grain, from one location to another.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one type of conveying apparatus including a gating system constructed in accordance with the present invention;

FIG. 2 is a schematical side elevational view of the gating system included in the apparatus of FIG. 1;

FIG. 3 is a side elevational view only of the upper blade assembly at the inlet of the passageway controlled by the gating system of FIG. 2;

FIG. 4 is a top plan view of the upper blade assembly of FIG. 3;

FIG. 5 is a bottom plan view of the upper blade assembly of FIG. 3;

FIG. 6 is a side elevational view of the lower blade assembly at the outlet of the passageway controlled by the gating system;

FIG. 7 is a top plan view of the lower blade assembly of FIG. 6;

FIG. 8 is a top plan view of the blade in the lower blade assembly of FIG. 6;

FIG. 9 is a bottom plan view of the lower blade assembly of FIG. 6;

FIG. 10 is an upper plan view of the lower open frame member in the lower blade assembly of FIG. 6;

FIG. 11 is a flow chart illustrating the overall operation of the gating system of FIGS. 2-10 in the conveying apparatus of FIG. 1;

FIG. 12 illustrates a modification in the construction of the drives for the blades in the gating system of FIGS. 1-1;

FIG. 13 illustrates another modification in the construction of the drives;

FIG. 14 illustrates a modification in the construction of the blade in the lower blade assembly at the outlet of the passageway controlled by the gating system;

FIG. 15 is a top plan view of the blade illustrated in FIG. 14;

FIG. 16 is a front view of the blade illustrated in FIG. 14; and

FIG. 17 illustrates conveying apparatus including two gating systems constructed in accordance with the invention.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

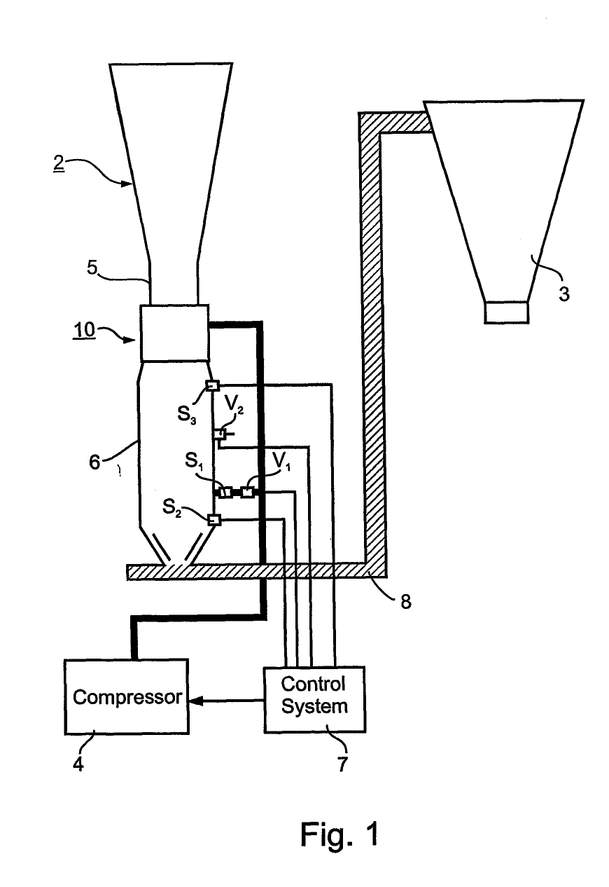

Overall Construction (FIGS. 1-10)

FIG. 1 illustrates one type of conveyor apparatus for which the present invention is particularly useful. The conveyor apparatus illustrated in FIG. 1 is for conveying flowable material, such as grain, from an input silo 2 to a remote silo 3 by pneumatic pressure supplied by a compressor 4. The flowable material is gravity fed from silo 2 via a passageway 5 into a buffering tank 6. Buffering tank 6 is provided with an inlet valve V₁ connecting compressor 4 to pressurize the tank, and with an outlet valve V₂ for depressurizing the tank. Compressor 4, as well as the two valves V₁, V₂, are controlled by control system 7, in the manner to be described below, to periodically pressurize tank 6 in order to convey its contents via a conduit 8 to the remote silo 3, and then to depressurize the tank in order to permit it to be refilled from the input silo 2.

Buffering tank 6 further includes a pressure sensor S₁ for sensing the pressure within the tank, a low-level sensor S₂ for sensing the empty condition of the tank, and a high-level sensor S₃ for sensing the full condition of the tank.

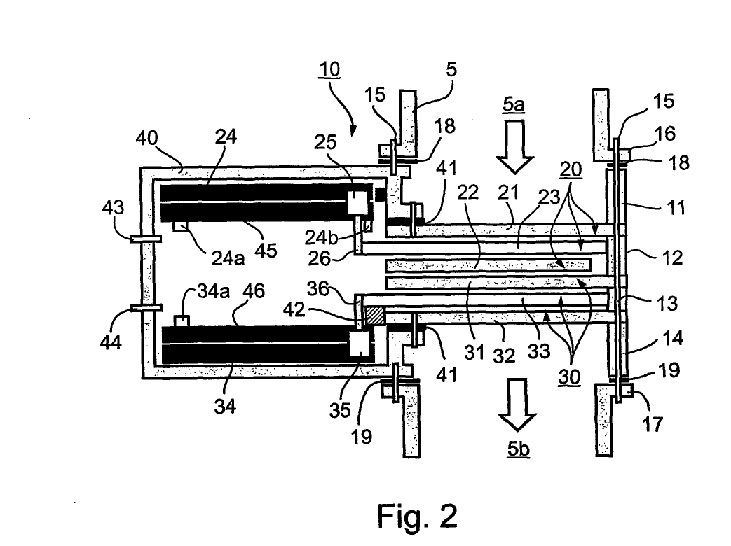

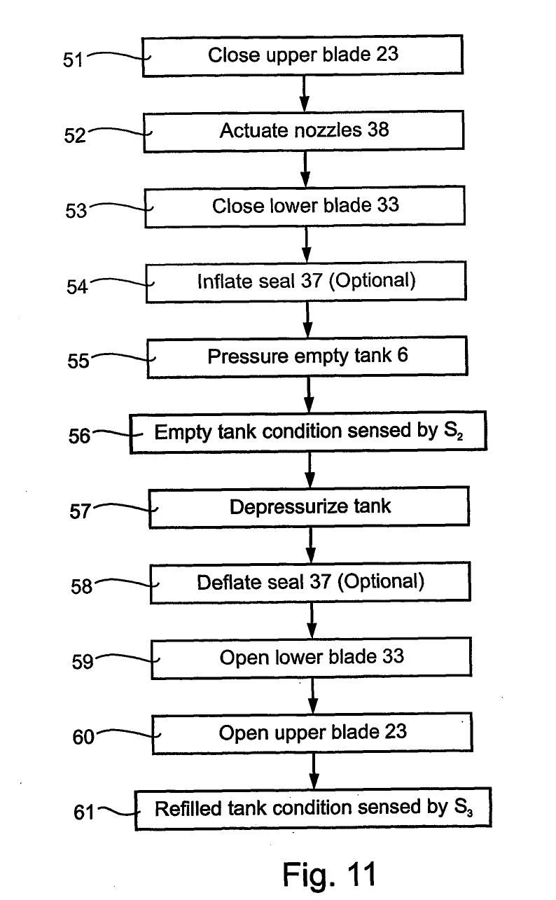

Buffering tank 6 is periodically refilled by gravity via a gating system, generally designated 10, constructed in accordance with the invention located within passageway 5 between tank 6 and the overlying input silo 2. Gating system 10, as more particularly illustrated in FIGS. 2-10. It is also controlled by control system 7 as more particularly described below with respect to the flow chart of FIG. 11.

As shown in FIG. 2, vertical passageway 5 receiving the gating system 10 is defined by a plurality of spacer elements 11, 12, 13, 14, secured together by tie rods 15 between a pair of flanges 16, 17, between the input silo 2 and buffering tank 6, respectively. A sealing gasket 18 is located between flange 16 and the upper spacing member 11, and another sealing gasket 19 is located between the lower sealing member 14 and flange 17.

As further shown in FIG. 2, gating system 10, located in vertical passageway 5 between silo 2 and tank 6, includes an input blade assembly, generally designated 20, between the passageway inlet 5a and outlet 5b, and an outlet blade assembly, generally designated 30, between the inlet blade assembly 20 and the passageway outlet 5b.

The inlet blade assembly 20 includes a pair of open frame members 21, 22, fixed within passageway 5, and an inlet blade 23 movable between the open frame members 21, 22 either to a closed position (shown in FIG. 2), or to an open position, with respect to passageway 5. Inlet blade 23 is moved to its two positions via a drive including a cylinder 24 and a piston 25 movable therein and coupled by arm 26 coupled to the inlet blade 23.

Similarly, the outlet or lower blade assembly 30 includes a pair of open frame members 31, 32, fixed in spaced relationship to each other within vertical passageway 5, and an outlet blade 33 movable to open and closed positions within the passageway by a drive including a cylinder 34 and a piston 35 movable therein and coupled by arm 36 to the outlet blade 33.

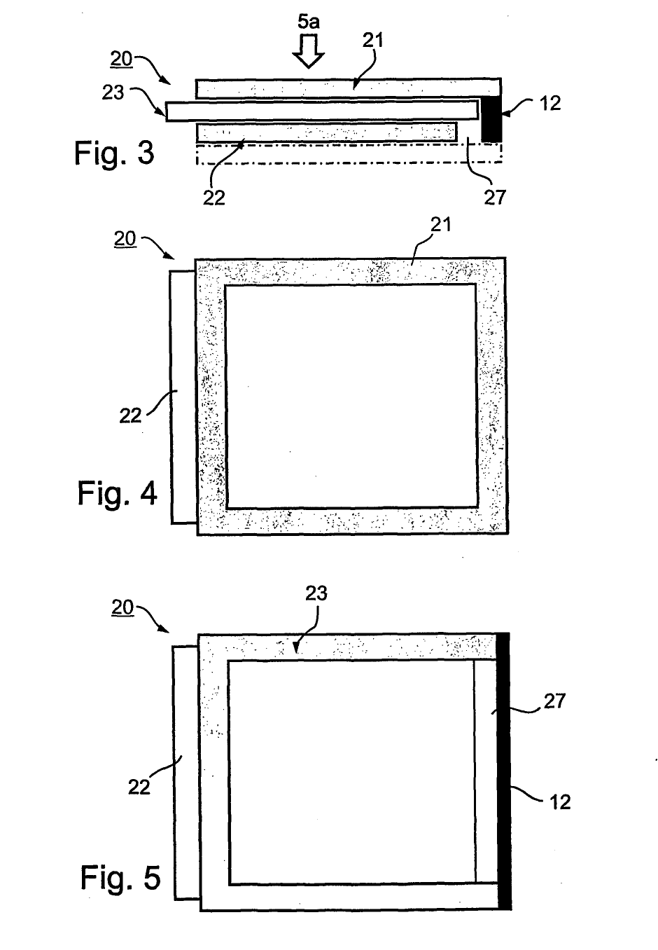

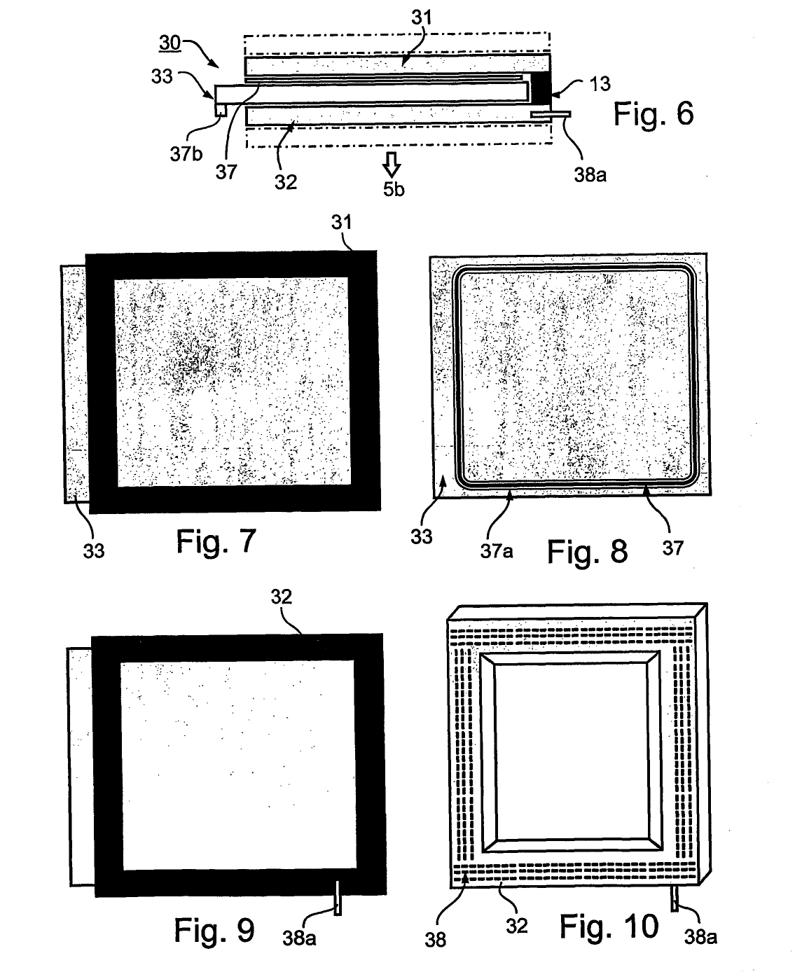

The construction of the inlet (higher) blade assembly 20 is more particularly illustrated in FIGS. 3-5; whereas the construction of the outlet (lower) blade assembly 30 is more particularly illustrated in FIGS. 6-10.

As shown in FIGS. 3-5, the two open frame members 21, 22 of the inlet blade assembly 20 are fixed within vertical passageway 5 by spacer 12. Both frame members, as well as the inlet blade 23 between them, are of a rectangular (square) configuration, but it will be appreciated that they could be of other configurations as well, e.g., a circular configuration. The upper open frame member 21 extends for the complete circumference (360°) of the frame member, whereas the lower frame member 22 extends for only about 270° of its circumference, being open at one side (right side, FIG. 5). The lower frame member 22 thus defines a space 27 for flowable material to pass therethrough during the closing of the inlet blade 23, as will be described more particularly below.

The outlet (lower) blade assembly 30, as more particularly illustrated in FIGS. 6-10, is also of rectangular (square) configuration, as the inlet blade assembly 20, but could also be of a different configuration (e.g., circular) to correspond to that of the inlet blade assembly. In this case, both frame members 31, 32 extend for the complete (360°) circumference of the blade assembly. They are fixed in the outlet end 5b of vertical passageway 5 by spacer 13.

As shown in FIGS. 6 and 8, the upper surface of the outlet blade 33 includes a sealing ring 37 located within an angular groove 37a formed in the upper surface of blade 33. Sealing ring 37 may be normally deflated to permit its blade 33 to move between the two open frame members 31, 32, and inflatable when the blade is in its closed position so as to engage the lower surface of the upper frame member 31 and thereby seal the space between blade 33 and frame member 31. The inflation and deflation of sealing ring 37 is effected via an air port 37b (FIG. 6) and is controlled by control system 7 (FIG. 1). While seal 37 is shown in FIG. 8 as being carried by blade 33, which thereby facilitates its periodic replacement, it may also be carried by the lower surface of the upper frame member 31. Also, an inflatable seal is not necessary, since the pressure applied to the tank during the conveying phase will press the lower blade, and its sealing ring 37, firmly against the underside of the upper frame member 31.

As shown particularly in FIG. 10, the upper surface of the lower open frame member 32 is formed with an annular array of openings 38 which serve as jet cleaning nozzles directing air jets upwardly towards the lower surface of the upper frame member 31 to flush same of any clinging particles during the opening and/or closing movements of the blade. The pressurized air for nozzles 38 is supplied via air port 38a controlled by control system 7 (FIG. 1).

The two drives, 24, 25 and 34, 35, respectively, for the two blades 23 and 33, are housed within a housing 40 (FIG. 2) laterally of the vertical passageway 5 between the input silo 2 and the buffering tank 6. As shown in FIG. 2, housing 40 is secured laterally of passageway 5 by tie rods 15, and is sealed with respect to that passageway by gaskets 18 and 19, as well as a further gasket 41 around an opening defined at one side of the spacer elements 11, 12 and 13. In addition, preferably another seal 42 is carried by the outlet (lower) blade 33, engageable with the lower frame member 32 when the outlet (lower) blade 33 is in its closed position (FIG. 2).

It will thus be seen that the interior of housing 40 is substantially sealed from the interior of vertical passageway 5, particularly when high air pressure is applied to buffering tank 6 as will be described below. Nevertheless, housing 40 may be periodically air-flushed by high-pressure air applied via an inlet port 43 and discharged via an outlet port 44.

The two drives for the two blade assemblies 20, 30 preferably include limit switches defining the open and closed positions of their respective blades 23, 33. Thus, as shown in FIG. 2, cylinder 24 includes a limit switch 24a engageable by its piston arm 26 in the open position of its blade 23, and another limit switch 24b engageable by arm 26 in the closed position of its blade. Similar limits which are provided on cylinder 34 defining the open and closed positions of its blade 33. Only limit switch 34a is seen in FIG. 2; the other limit switch may be embedded within seal 42.

In the construction illustrated in FIG. 2, the pistons 25, 35 are coupled to their respective upper blade 23 and lower blade 33 by arms 26, 36 extending laterally of the respective cylinder 24, 34. Accordingly, the cylinders would have to be provided with elongated slots to accommodate these arms. Since the interior of housing 40 is not perfectly isolated from the flowable material, the elongated slots formed in the cylinders 24, 34 are preferably covered by a displaceable cover which normally seals the respective slots but permits the lateral arms 26, 36 to move along the linear slots in the cylinders. As one example, the covers 45, 46 may be of a silicon rubber or other elastomeric material formed with a slit having overlapping edges which tend to seal the interior of the respective cylinder but permit the lateral arm 26, 36, to move there along for coupling the respective blade 23, 33, to the respective piston 25, 35.

Operation (FIG. 11) and Some Advantages

The operation of the apparatus illustrated in FIGS. 1-10 will now be described particularly with reference to the flow chart of FIG. 11.

It will be assumed that the two blades 23, 33 of the two blade assemblies 20, 30, are in their open positions, and that a batch of the flowable material has passed through vertical passageway 5 into the buffering tank 6 as determined by the upper level sensor (S₃) in the tank. The flow chart illustrated in FIG. 11 describes a cycle of operation for conveying the contents of tank 6 via conduit 8 to the remote silo 3, and then for refilling tank 6 with another batch of the flowable material from the input silo 2.

Thus, the first operation illustrated in the flow chart of FIG. 11 is to close the inlet (upper) blade 23. For this purpose, control system 7 actuates the drive (piston 25 movable within cylinder 24) of the upper blade assembly 20 to move its blade 23 to its closed position (block 51). During this closing movement of the upper blade 23, any material in the space between its frame members 21, 22 would be pushed by the closing blade to fall through its lower frame member 22 and through the open lower blade assembly 30 into the tank 6. During the final closing movement of blade 23 such material would be pushed into space 27 at the end of its lower frame member 22.

After the upper blade 23 has been fully closed, control system 7 is controlled to actuate nozzles 38 (block 52), and then to actuate the drive (piston 35 movable within cylinder 34) to move the lower blade 33 to its closed position (block 52). Thus, during this closing movement of the lower blade 33, the air nozzles 38 in the lower frame member 32 of the lower blade assembly 30 are activated with air to flush away any material clinging to the underside of the upper frame member 31 of the lower blade assembly 30 and to permit such material to fall into tank 6 (block 53). This better assures that seal 37 will remain clean.

During the closing movements of the lower blade 33, its seal 37 is in a deflated condition to facilitate this movement of the blade. As soon as the lower blade 33 has reached its closed position, its inlet seal 37 is inflated to thereby firmly engage the upper frame member 31 of the lower gate assembly 30, and thereby to seal this part of the passageway 5 (block 54). As indicated earlier seal 37 need not be an inflatable one since the pressure applied by tank 6 to the lower blade 33 will press that blade, and its seal 37, against the underside of frame member 31 to effect a good seal. Thus, an important advantage of the novel gating system is the greater the system pressure, the better the seal.

When the tower blade 33 is thus firmly closed, seal 42 prevents any leakage of pressure from tank 6 to the interior of housing 40. This reduces the necessity of providing housing 40 with a good seal.

At this time, control system 7 actuates compressor 4 to apply high pressure via valve V2 to the interior of tank 6, and thereby to transfer its contents via conduit 8 to the remote silo 3 (block 55). This continues until the tank is emptied, as indicated by the low-level sensor S₂ within the tank (block 56).

As soon as the tank has thus been emptied, control system 7 interrupts the pressure supplied by compressor 4 to the tank (block 57); deflates seal 37 carried by the lower blade 33 (block 58); drives the lower blade 33 to its open position (block 59); and then drives the upper blade 23 to its open position (block 60).

With both blades 23 and 33 thus in their open positions, tank 6 is permitted to refill by gravity until its upper level sensor S₃ is actuated (block 61) to thereby start a new cycle for conveying the contents of tank 6 to the remote silo 3 and then for refilling the tank.

It will thus be seen that the novel gating system 10, including the two blades 23, 33, provides a number of important advantages over gating systems previously used in such conveying apparatus. Thus, when closing the gating system 10 within passageway 5, the upper blade 23 is closed first, i.e., while the lower blade is still open, whereby the movement of the lower blade to its open position is effected in a relatively clean environment. In addition, when the high pressure is applied to tank 6, seal 37 of the lower blade assembly 30 substantially isolates everything above the lower blade 33 from the high pressure. Thus, as distinguished from other gating systems which are limited as to the pressure they can tolerate, the gating system of the present invention is virtually unlimited in this respect, since the greater the system pressure, the better the seal. After the contents of tank 6 have been conveyed to the remote silo 3 by the high pressure applied to the tank and the high pressure has been released, only then is the gating system actuated to its open position. This is done by first opening the lower blade 33, effected in a relatively clean environment, and then opening the upper blade 23 to permit tank 6 to be refilled with a new batch of the flowable material.

The new gating system is thus simple, reliable, less costly, considerably more compact, and/or simpler to maintain, as compared to gating systems of other constructions. These advantages make the novel gating system particularly useful in pneumatic conveying apparatus and, in most cases, obviates the need for complex constructions and excavations heretofore required in conveyance sites.

Some Variations and Modifications

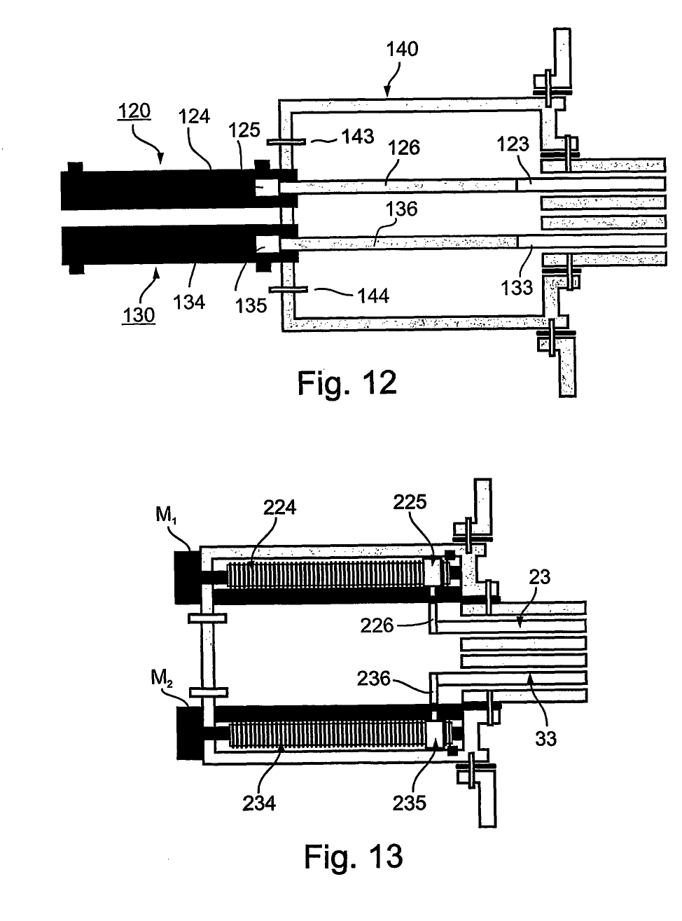

FIG. 12 illustrates a variation with respect to the drives for the two blade assemblies, therein designated 120, 130, respectively. Thus, the drives illustrated in FIG. 12 are also constituted of pistons 125, 135, movable within cylinders 124, 134, respectively, and coupled by coupling members 126, 136, to the blade 123, 133, of the respective blade assembly. However, in the construction illustrated in FIG. 12, the cylinders 124, 134, are located outside of the housing 140, and their respective pistons 125, 135, are coupled by piston stems 126, 136, to the respective blades 123, 133. Thus, the cylinders 124, 134 are substantially isolated from the flowable material which may penetrate into housing 140, and therefore do not require the special sealing arrangements as described above with respect to FIGS. 2-10. Housing 140, however, is preferably also periodically flushable of any material accumulating therein via an inlet flushing port 143 and an outlet flushing 144.

FIG. 13 illustrates a construction similar to that of FIGS. 2-10, except that the drives for the upper and lower blades 23, 33, are screw drives, rather than piston-cylinder drives. Thus, as shown in FIG. 13, the drive for the upper blade 23 includes a screw 224 rotated by a motor M₁ to drive a nut 225 coupled by arm 226 to the upper blade 23; whereas the drive for the lower blade 33 includes another screw 234 driven by motor M₂ for driving a nut 235 coupled by arm 236 to the lower blade 233. In substantially all other respects, the construction and operation of the arrangement illustrated in FIG. 13 are substantially the same as described above with respect to FIGS. 2-11.

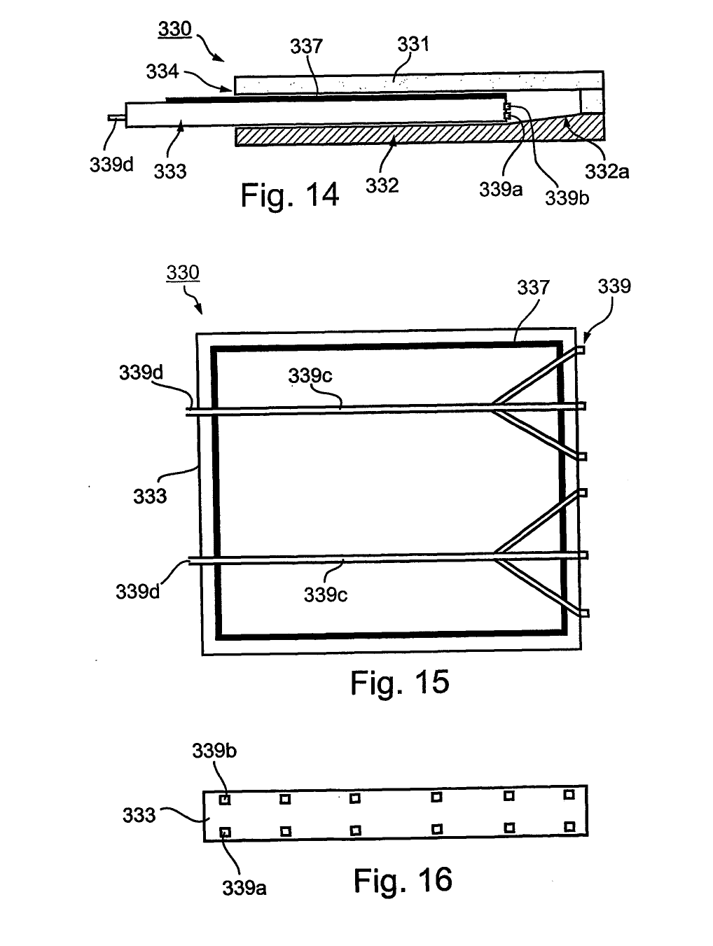

FIGS. 14-16 illustrate several modifications in the construction of the lower blade assembly, therein designated 330.

One such modification is that the upper surface of the lower open frame member 332 is upwardly inclined, as shown at 332a, at the end thereof engaged by the lower blade 333 at the end of the travel of the blade to its closed position, such that inclined surface 332a tends to enhance the seal produced by seal 337 with respect to frame member 331 in the closed condition of the lower blade 333. As shown by arrow 334, there is a sufficient space between the upper frame member 331 and the seal 337 on the lower blade to avoid contact with the seal during the opening and closing movements of the blade. This feature also avoids the need for an inflatable seal.

Another modification included in the lower blade assembly 330 illustrated in FIGS. 14-16 is the provision of a plurality of air jet nozzles, generally designated 339, along the leading edge of the lower blade 333 as it moves towards its closed position. Thus, as shown in particularly in FIG. 16, nozzles 339 include a lower linear array of nozzles 339a oriented to direct air jets against the upper surface of the lower frame member 332 to free those surfaces of clinging material, and an upper linear array of nozzles 339b oriented to direct air jets against the lower surface of the upper frame member 331 during the closing movements of the lower blade 333. These jet nozzles are supplied by pressurized air via channels 339c terminating in inlet port 339d formed in the lower blade 333.

In all other respects, the gating system illustrated in FIGS. 14-16 is constructed and operates in the same manner as described above.

The foregoing constructions illustrate a batch process, wherein a batch of the flowable material is discharged from the input silo 2 into tank 6 and then conveyed by pneumatic pressure to the remote silo 3 via conduit 8. Accordingly, each conveying period is interrupted by a non-conveying period during which the tank 6 is filled from the silo.

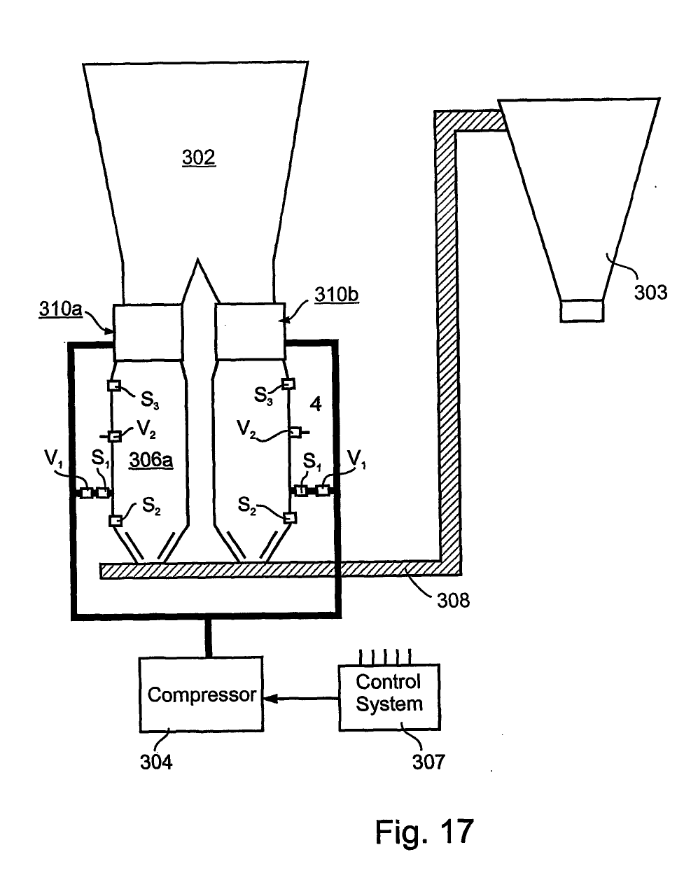

FIG. 17 illustrates apparatus wherein the delay between the batches is minimized by providing two tanks 306a, 306b each underlying a gating system 310a, 310b both supplied from different portions of a common silo 302. Thus, the control system 307 in the apparatus of FIG. 17 controls the drives in the two gating systems 310a, 310b, as well as the compressor 304 and the valves V₁, V₂, to alternatingly fill one tank with the flowable material from silo 2 via its respective gating system, while pressurizing the other tank to convey its contents to the remote silo 303. Thus, the throughput of such an apparatus is substantially doubled.

While the invention has been described with respect to several preferred embodiments, it will be appreciated that these are set forth merely for purposes of example, and that many of the described features could be used without others, and many further variations, modifications and applications of the invention may be made.

What is claimed is:

1. A gating system for controlling the flow of a flowable material through a passageway having an inlet and an outlet, said gating system comprising:
an inlet blade assembly between said passageway inlet and passageway outlet, said inlet blade assembly including an inlet blade and a drive for moving said inlet blade to open and closed positions with respect to said passageway;
an outlet blade assembly between said inlet blade assembly and said passageway outlet, said outlet blade assembly including an outlet blade and a drive for moving said outlet blade to open and closed positions with respect to said passageway;
and a control system for controlling said drives for moving said inlet blade to its closed position before moving said outlet blade to its closed position with respect to said passageway, and for moving said outlet blade to its open position before moving said inlet blade to its open position with respect to said passageway.

2. The gating system according to claim 1, wherein said outlet blade assembly includes a seal cooperable with said outlet blade when in its closed position to seal said passageway and said inlet blade assembly therein.

3. The gating system according to claim 2, wherein said seal is carried by said outlet blade.

4. The gating system according to claim 2, wherein said seal is an inflatable seal; and wherein said control system inflates said seal after the outlet blade has been moved to its closed position, and deflates said seal before the outlet blade is moved to its open position.

5. The gating system according to claim 1, wherein said inlet blade assembly includes a pair of open frame members between which said inlet blade is movable to its open and closed positions.

6. The gating system according to claim 5, wherein the open frame member of the inlet blade assembly facing the outlet blade assembly is interrupted to permit passage to the outlet blade assembly of flowable material located between the two frame members of the inlet blade assembly during the movement of the inlet blade to its closed position.

7. The gating system according to claim 1, wherein said outlet blade assembly includes a pair of frame members between which said outlet blade is movable to its open and closed positions.

8. The gating system according to claim 7, wherein the open frame member of the outlet blade assembly proximal to the passageway outlet carries, on its surface facing the other open frame member of the outlet blade assembly, a plurality of jet cleaning nozzles controlled by said control system for discharging cleaning jets towards the outlet blade to clean it during the opening and/or closing movements of the outlet blade.

9. The gating system according to claim 7, wherein said outlet blade carries a plurality of jet cleaning nozzles controlled by said control system for cleaning said open frame members of the outlet blade assembly during the opening and/or closing movements of the outlet blade.

10. The gating system according to claim 7, wherein the open frame member of the outlet blade assembly facing away from the inlet blade assembly is formed with an inclined surface to move the outlet blade towards the open frame member of the outlet blade assembly facing the inlet blade assembly during the end movement of the outlet blade to its closed position.

11. The gating system according to claim 1, wherein said drives are enclosed in a common housing; and wherein said housing includes an air inlet and an air outlet for air flushing the interior of said housing.

12. The gating system according to claim 1, wherein each of said drives includes a drive member, a driven member, and an arm extending through an elongated, sealed slot in said drive member and coupling said driven member to its respective blade.

13. The gating system according to claim 12, wherein in each of said drives, said drive member is a cylinder, and said driven member is a piston movable therein.

14. The gating system according to claim 12, wherein in each of said drives, said drive member is a screw, and said driven member is a nut movable thereon.

15. The gating system according to claim 1, wherein said passageway is a vertical passageway, said inlet an outlet blades are horizontal blades, and said flowable material flows through said passageway by gravity, whereby said inlet blade assembly is an upper blade assembly, and said outlet blade assembly is a lower blade assembly underlying said upper blade assembly.

16. The gating system according to claim 15, wherein said passageway outlet communicates with a tank of said flowable material; and wherein said tank includes a source of pressurized gas for conveying the flowable material from said tank to another destination.

17. The gating system according to claim 16, wherein said control system also controls said source of pressurized gas to pressurize said tank only when said outlet blade of the outlet blade assembly has been moved to its closed position.

18. Conveying apparatus for conveying a flowable material, said conveying apparatus comprising:
a gating system according to claim 1;
a container for containing a quantity of flowable material and for feeding same by gravity to the inlet of said passageway;
a tank communicating with the outlet of said passageway; and
a source of pressurized gas to pressurize said tank and to convey the flowable material therein to another destination; said control system also controlling said source of pressurized gas to pressurize said tank only when the outlet blade of the outlet blade assembly has been moved to its closed position.

19. The conveying apparatus according to claim 18, wherein the apparatus comprises two gating systems, each underlying a part of said container, and two tanks, each underlying one of said gating systems and communicating with said source of pressurized gas;
and wherein said control system controls said drives of the gating systems and said source of pressurized gas to alternatingly fill one tank with flowable material from said container via its gating system, while pressurizing the other tank to convey its contents to said another destination.
